(19) United States
(12) Patent Application Publication
(10) Pub. No.: US 2023/0276735 A1
(43) Pub. Date: Sep. 7, 2023

(54) SYSTEMS AND METHODS FOR CONTROLLING UNLOADING OF AGRICULTURAL MATERIAL

(71) Applicant: DEERE & COMPANY, MOLINE, IL (US)

(72) Inventors: STEPHEN R. CORBAN, GENESEO, IL (US); Grant J. Wonderlich, Milan, IL (US)

(21) Appl. No.: 17/653,652

(22) Filed: Mar. 6, 2022

(51) Int. Cl. A01D 90/10; G01G 15/00

(52) U.S. Cl. CPC A01D 90/10; G01G 15/006; G01F 23/292

(57) ABSTRACT

Systems and methods for monitoring a weight of agricultural material, such as grain, unloaded from a first vehicle, such as a harvester (e.g., a combine harvester), to a second vehicle, such as a grain cart, and stopping transfer of the agricultural material when a sensed weight of the unloaded agricultural material contained in the second vehicle meets or exceeds a selected amount are disclosed. Example systems and methods may also include monitoring a fill level of agricultural material unloaded into the second vehicle simultaneously with monitoring the weight of unloaded agricultural material.

### FIELD OF THE DISCLOSURE

The present disclosure relates generally to controlling transfer of agricultural material from one vehicle to another and, particularly, controlling transfer of agricultural material from one vehicle to another as the vehicles are moving along the ground.

### BACKGROUND OF THE DISCLOSURE

During a harvesting operation, agricultural material, such as grain, present on a harvester is offloaded to another vehicle, such as grain cart. The agricultural material is offloaded from the harvester so that the harvester can continue harvesting. Offloading of the grain from the harvester to a grain cart can occur as the harvester is traveling and continuing to harvester the agricultural material.

### SUMMARY OF THE DISCLOSURE

A first aspect of the present disclosure is directed to a system to control transfer of agricultural material from one vehicle to another. The system may include a first vehicle that includes a first storage bin that stores agricultural material and an agricultural material conveyor. The system may also include a second vehicle including a second storage bin that stores agricultural material conveyed by the agricultural material conveyor from the first storage bin of the first vehicle and a sensor that detects a weight of agricultural material contained in the second storage bin. The sensor may generate a first signal representative of the detected weight. The system may also include a controller that is configured to receive the first signal and, using the received signals, determine whether the detected weight satisfies a selected condition, and stop operation of the agricultural material conveyor to stop transfer of agricultural material from the first vehicle to the second vehicle when the selected condition is satisfied.

Another aspect of the present disclosure is directed to computer-implemented method for controlling transfer of agricultural material from one vehicle to another. The method may include sensing, with a first sensor, a weight of agricultural material contained in a storage bin of a first vehicle and being delivered to the storage bin via an agricultural material conveyor of a second vehicle; comparing, with an electronic controller, the sensed weight of the agricultural material with a selected condition; and transmitting a first signal to the agricultural material conveyor to stop operation of the agricultural material conveyor when the sensed weight of the agricultural material in the storage bin satisfies the selected condition.

The various aspects of the present disclosure may include one or more of the following features. The controller may include a controller configured to transmit a second signal to the first vehicle to stop operation of the agricultural material conveyor automatically. The selected condition may be a selected weight of agricultural material contained in the second storage bin. A fill level system may be configured to detect a fill level of agricultural material in the second storage bin of the second vehicle. The controller may be configured to determine when a fill level of the agricultural material in the second storage bin of the second vehicle has reached a selected fill level and cause the agricultural material conveyor to stop operation when the selected fill level has been reached. The controller may be configured to stop operation of the agricultural material conveyor when the weight of the agricultural material in the second storage bin reaches selected weight notwithstanding that the fill level of the agricultural material in the second storage bin has not reached the selected fill level. The fill level system may include an imaging system that detects a fill level of the second storage bin using image data. The imaging system may include at least one camera. The at least one camera may be at least one stereo camera. The agricultural material conveyor may be operable to convey the agricultural material from the first storage bin of the first vehicle to the second storage bin of the second vehicle as the first vehicle and second vehicle are traveling over a surface. The sensor may include a scale coupled to the first storage bin.

The various aspects may include one or more of the following features. The agricultural material may be transferred from the first vehicle to the second vehicle while traveling over a surface. A fill level of the agricultural material in the storage bin may be detected with a second sensor. The sensed fill level may be compared with a second selected condition. A second signal may be transferred to the agricultural material conveyor to stop operation of the agricultural material conveyor when the sensed fill level satisfies the second selected condition. The second selected condition may be a selected fill level. Transmitting a first signal to the agricultural material conveyor to stop operation of the agricultural material conveyor when the sensed weight of the agricultural material in the storage bin satisfies the selected condition may occur notwithstanding that the sensed fill level does not satisfy the second selected condition. The second sensor may be an image system. The imaging system may include at least one camera. The at least one camera may include at least one stereo camera. The first sensor may include a scale. Transmitting a first signal to the agricultural material conveyor to stop operation of the agricultural material conveyor when the sensed weight of the agricultural material in the storage bin satisfies the selected condition may include automatically stopping the agricultural material conveyor in response to receipt of the first signal.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 a perspective view showing a harvester unloading agricultural material into a grain cart, according to some implementations of the present disclosure.

FIG. 2 is a schematic view of an example grain cart, according to some implementations of the present disclosure.

FIG. 3 is a schematic view of an example control system for automatically monitoring a weight of agricultural material being unloaded and controlling an operation of an agricultural material conveyor, according to some implementations of the present disclosure.

FIG. 4 is an example grain cart, according to some implementations of the present disclosure.

FIG. 5 is an example control system for automatically monitoring a weight and fill level of agricultural material being unloaded and controlling an operation of an agricultural material conveyor, according to some implementations of the present disclosure.

FIG. 6 is a flowchart of an example method for controlling an operation of an agricultural material conveyor in response to a sensed weight or both a sensed weight and a sensed fill level, according to some implementations of the present disclosure.

FIG. 7 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to systems and methods for monitoring a weight of agricultural material, such as grain, unloaded from a first vehicle, such as a harvester (e.g., a combine harvester), to a second vehicle, such as a grain cart, and stopping transfer of the agricultural material when a sensed weight of the unloaded agricultural material contained in the second vehicle meets or exceeds a selected amount. Further, the present disclosure also encompasses implementations in which a fill level of the agricultural material in the second vehicle is monitored and transfer of the agricultural material to the second vehicle is stopped notwithstanding that a fill level of the agricultural material has not reached a selected fill level.

While the present disclosure is provided in the context of transferring agricultural material from a first vehicle (e.g., a harvester) to a second vehicle (e.g., a grain cart) during the course of a harvesting operation, the scope of the disclosure is not so limited. Rather, the present disclosure encompasses other types of vehicle as well as the transfer of agricultural material from one vehicle to another outside of a harvesting operation.

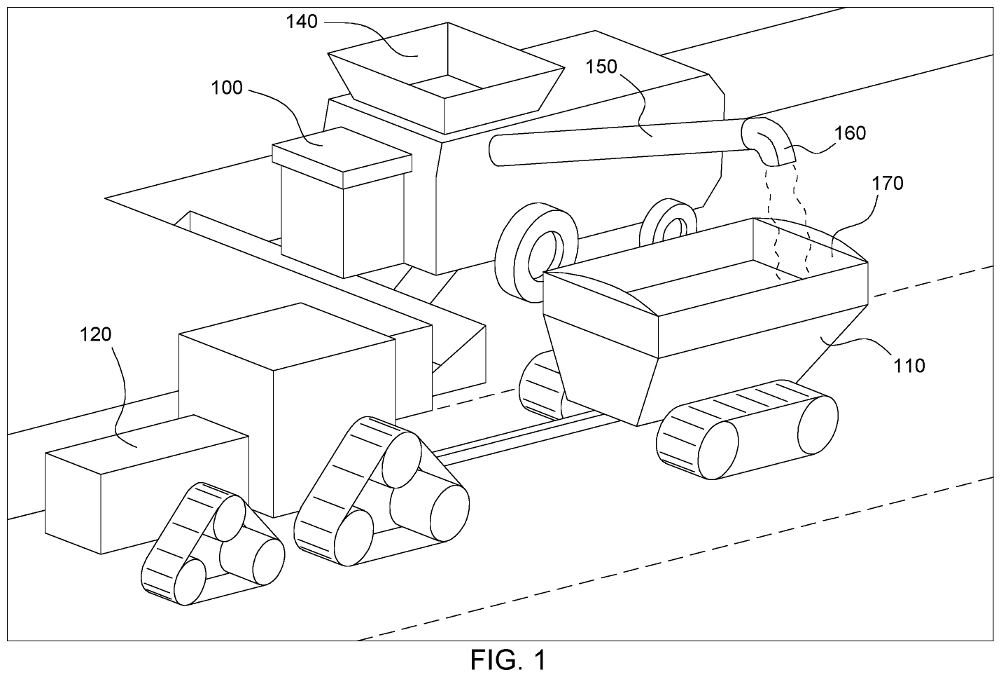

FIG. 1 is a perspective view showing a harvester 100, particularly a combine harvester, and a grain cart 110. The harvester 100 is unloading agricultural material to the grain cart 110. In the illustrated example, the agricultural material is grain processed by the harvester 100. In the illustrated example, the grain cart 110 is pulled by a tractor 120. However, in other implementations, the grain cart 110 is self-propelled and, therefore, the tractor 120 is omitted. Grain cart 110 encompasses any mobile apparatus that includes a storage bin for receiving agricultural material.

The harvester 100 includes a storage bin 140. Agricultural material, such as grain, is stored in the storage bin 140. In some implementations, such as where the harvester 100 is a combine harvester, the storage bin 140 stores agricultural material that has been processed by the harvester 100. Generally, the processed agricultural material is grain. However, in other implementations, other types of agricultural material, whether processed or unprocessed, is stored in the storage bin 140.

During the course of a harvesting operation, the storage bin 140 fills with the agricultural material and, in order to allow for continued harvesting, the agricultural material is unloaded to the grain cart 110 when the amount of agricultural material in the storage bin 140 reaches a selected level. When agricultural material is to be unloaded from the harvester 100, the grain bin 110 is brought along side of the harvester 100, and an unloader 150 of the harvester 100 is extended. The unloader 150 houses a conveyor, such as a screw conveyor (e.g., a screw auger), that conveys the agricultural material stored in the storage bin 140 to a spout 160. In other implementations, other types of conveyors are used. When the conveyor is operated, agricultural material contained in the storage bin 140 is conveyed from to the spout 160, where the agricultural material is expelled, into a storage bin 170 of the grain cart 110. Unloading of the agricultural material proceeds until a selected amount of agricultural material is delivered to the storage bin 170 of the grain cart 110.

Generally, it is desired to fully empty the storage bin 140 during unloading because, in such circumstances, the harvester 100 is able to operate for a longer period before another unloading operation is needed. It is also noted that unloading can be performed while the harvester 100 continues to perform a harvesting operation. That is, unloading can be performed while the harvester 100 continues to move through a field harvesting crop. In such instances, agricultural material is continued to be deposited into the grain bin 140 as the agricultural material is being simultaneously unloaded to the grain cart 110. In some implementations, unloading is stopped, for example, when a selected amount of agricultural material is unloaded from the grain bin 140 or a level or amount of agricultural material remaining in the storage bin 140 reaches a selected level.

Generally, other factors are considered when determining how much agricultural material is unloaded. For example, a size of the storage bin 170 of the grain cart 110 is considered. In some implementations, if the storage bin 170 already contains an amount of agricultural material, an amount of available storage space in the storage bin 170 of the grain cart 110 is also considered. Other factors may also be considered.

In some instances, agricultural material contained in a grain cart is unloaded into trailers that are transported over a road. Further, roads may have loading restrictions. Therefore, an amount of agricultural material in a grain cart may be limited to an amount that is able to fill a selected number of trailers to a selected level that satisfies a loading restriction for a road. In some instances, the grain cart is transported along a road. Therefore, a weight of the agricultural material contained in the grain cart is limited to comply with road loading restrictions. Thus, an amount of agricultural material transferred to the grain cart is controlled in order, for example, to comply with loading restrictions of roads.

Other considerations may also include a fill level of agricultural material in the grain cart. An amount of agricultural material introduced into the storage bin of a grain cart may be selected based on a terrain over which the grain cart travels. For example, topography of the terrain over which a grain cart travels may have a slope such that agricultural material may spill out of the grain cart and onto the ground if a fill level of the agricultural material exceeds a selected amount. The fill amount of agricultural material in the grain cart may vary depending on one or more conditions, such as characteristics of the terrain (e.g., slope) or crop characteristics (e.g., crop moisture).

Therefore, an amount of agricultural material unloaded from the harvester 100 to the grain cart 110 is controlled.

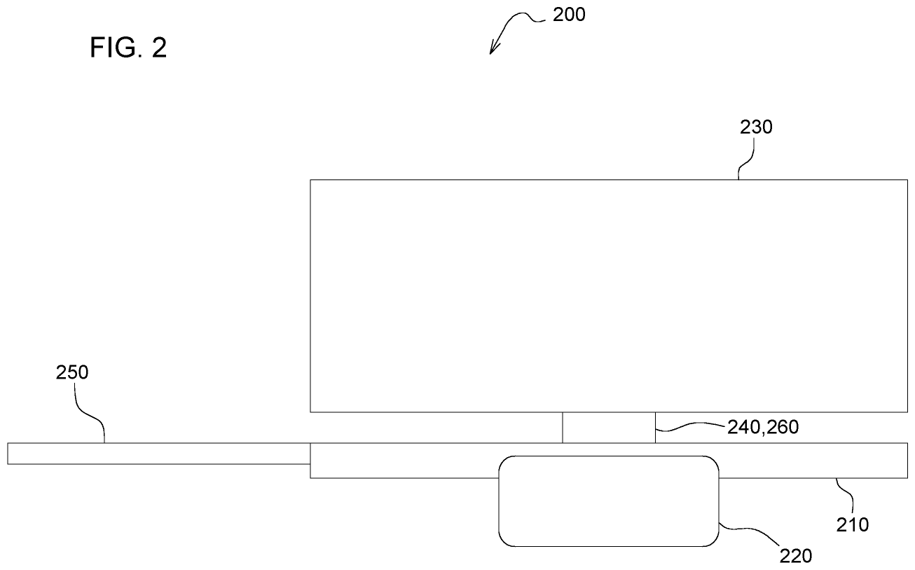

FIG. 2 is a schematic view of an example grain cart 200. The grain cart 200 may be similar to the grain cart 110 shown in FIG. 1. The grain cart 200 includes a frame 210, ground engaging components 220 (e.g., one or more wheels or tracks) mounted to the frame 210, a storage bin 230 mounted to the frame 210, and a sensor 240 that senses a weight of the storage bin 220. In some implementations, more than one sensor 240 is used to sense a weight of the storage bin 220 and any contents thereof. For example, in some instances, a sensor 240 is provided on each axle of the grain cart 200. In some instances, a sensor 240 is provided on the tongue 250. Thus, the scope of the present disclosure is intended to encompass any number of sensors 240 (e.g., one or more sensors) to sense a weight of the storage bin 220 and any contents thereof. In some implementations, determining a weight of the storage bin 220 using a plurality of sensors 240 is performed by summing a weight sensed by each sensor 240. However, determining a weight of the storage bin 220 using a plurality of sensors 240 is not limited to summing sensed weights but, rather, encompasses any mathematical relationship or algorithm using the sensed weight information to arrive at the weight of the storage bin 220 and any contents thereof. Thus, although a single sensor 240 may be described in the examples provided herein, it is understood that the disclosure encompasses the use of a plurality of sensors 204. In some instances, the sensor 240 is calibrated to remove an empty weight of the storage bin 230, thus, sensing a weight of the agricultural material free from the weight of the storage bin 230. The grain cart 200 also includes a tongue 250 attached to or forming part of the frame 210. A vehicle, such as a tractor, connects to the grain cart 200 with the tongue 250. In other implementations, the grain cart 200 can be self-propelled.

As agricultural material is deposited into the storage bin 230, the sensor 240 senses a weight of the deposited agricultural material. In some implementations, the sensor 240 is a scale, such as a digital scale. In some implementations, the sensor 240 is a plurality of sensors, such as a plurality of scales, that detect weight of a portion of the storage bin 230. In such instances, the weights sensed by the different sensors are combined to measure a total weight of the deposited agricultural material. Thus, in some implementations, more than one sensor is used to detect a weight of agricultural material deposited in a storage bin of a grain cart.

In some implementations, the sensor 240 or plurality of sensors 240, as the case may be, form part of a control system 260. In some implementations, the control system 260 is an electronic controller that includes one or more computers systems. Example computer systems are described in more detail below. The control system 260 may be localized to the grain cart 200 or distributed across the grain cart 200 and one or more other locations. For example, in some instances, a portion of the control system 260 is located on a harvester, such as a combine harvester. The control system 260 operates to monitor a weight of the agricultural material introduced into the storage bin 230 of the grain cart 200 and, when a selected weight is detected, cause transfer of the agricultural material to the storage bin 230 to cease.

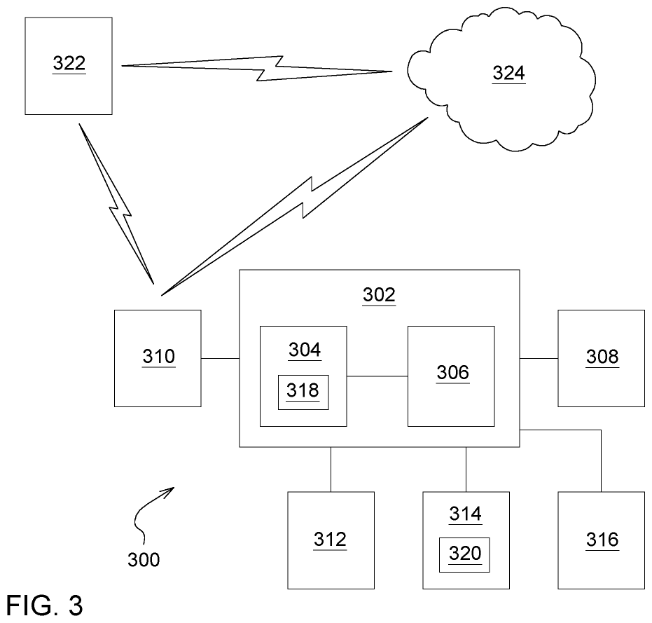

An example control system 300 is shown in FIG. 3. Control system 300 may be similar to control system 260 and located, at least partially, on a grain cart or other agricultural storage vehicle. Communication among the various components of the control system 300 may be performed via wired or wireless communication. The control system 300 includes an electronic controller 302 having a processor 304 and a memory 306 that is communicably coupled to the processor 304, a weight sensor 308, a transmitter 310, an input device 312, a display 314, and a database 316. The illustrated control system 300 is provided merely as an example. One or more components or features of the example control system 300 may be omitted or one or more components or features may be added and still remain within the scope of the present disclosure. For example, in some instances, the display 314 or database 316 may be omitted. In some implementations, the controller 302 forms or includes an electronic computer system, such as the computer system 700, described in more detail below. Additional details of the controller 302, such as processor 304 and memory 306, are described below in the context of computer system 700.

The memory 306 communicates with the processor 304 and is used to store programs and other software, information, and data. The processor 304 is operable to execute programs and software and receive information from and send information to the memory 306. Although a single memory 306 and a single processor 304 are illustrated, in other implementations, a plurality of memories, processors, or both may be used. Although the processor 304 and the memory 306 are shown as being local components of the controller 302, in other implementations, one or both of the processor 304 and memory 306 may be located remotely. Software 318, such as in the form of an application or program, is executed by the processor 304 to control operation of the control system 300, as described in more detail below.

The input device 312 is communicably coupled via a wired or wireless connection. Example input devices 312 include a keyboard, keypad, one or more buttons, a slider bar, a dial, a knob, a mouse, or a joystick. The display 314 is communicably coupled to the controller 302 via a wired or wireless connection. The display 314 displays information, such as information related to the operation of control system 300. For example, information displayed by the display 314 includes a current sensed weight of agricultural material contained in a storage bin of a grain cart, a selected target weight of agricultural material to be deposited in the grain cart, or an operating status of an unloader of a harvester that may be depositing agricultural material into the storage bin of the grain cart. In some instances, the information displayed by the display 314 is displayed via a graphical user interface 320. Example displays include cathode ray tubes (CRT), liquid crystal displays (LCDs), or plasma displays. Other types of displays are also within the scope of the present disclosure. In some implementations, the display 314 is a touch screen that is operable to receive input from a user via a user's touch. In some implementations in which the display 314 is a touch screen, the input device 312 is omitted.

The database 316 is an electronic storage device that is used to store software, applications, and data. The database 316 may be provided locally or remotely. For example, in some implementations, the database 316 may be located on a grain cart or located remotely from the grain cart and accessed remotely. The transmitter 310 is communicably coupled to the controller 302 and operates to send, receive, or both send and receive information, such as one or more signals. For implementations, in which the transmitter 310 is operable to both send and receive signals, the transmitter 310 is in the form of a transceiver. For the purposes of simplicity, transmitter 310 is used to encompass implementations having transmit and transmit and receive functionality.

The example control system 300 also includes a receiver 322. The receiver 322 is located on a vehicle that transfers agricultural material to the grain cart, such as a harvester. Similar to the transmitter 310, the receiver 322 may have both receive and transmit functionality.

The control system 300 may be localized to a grain cart, such as grain cart 200, or distributed across the grain cart and one or more other locations, such as a harvester. In some implementations, the sensor 308 and transmitter 310 may be provided locally on a grain cart while the controller 304 (and, in some instances, one or more other components of the control system 300) is located remotely from the grain cart. For example, in some instances, the controller 304 is located on a harvester. In other instances, the controller 302 is located at another location. For implementations in which the controller 302 is provided on a harvester, the controller 302 receives signals from the sensor 308 (provided via signals from the transmitter 310 on the grain cart and received by the receiver 322 located on the harvester) and, in response, sends signals to one or more actuators, either directly, via a network, or via a control system of the harvester, to control operation of an agricultural material conveyor of the harvester.

In operation, the controller 302 receives signals from the sensor 308 representing a weight of agricultural material present in a storage bin of a grain cart. Using software 318, the controller 302 compares the sensed weight with a selected condition, such as a selected weight. In some implementations, the selected weight is a maximum weight of agricultural material that is to be deposited into a storage bin of the grain cart. In some instances, the selected weight relates to a weight limitation for a road, a weight selected to reduce an amount of field compaction, or some other desired condition. If the sensed weight satisfies the selected condition, the controller 302 transmits instructions (such as in the form of signals), via the transmitter 310, to the receiver 322. The receiver 322 relays the instructions to stop operation of an agricultural material conveyor that is conveying the agricultural material to the storage bin of the grain cart.

In some implementations, the instructions received by the receiver 322 are provided to a control system of the harvester, and the harvester, in response to the received instructions, commands the agricultural material conveyor to stop conveying agricultural material. In this way, the weight of the agricultural material conveyed to the grain cart is controlled to a selected amount.

In some implementations, the selected weight reflects an amount of grain that is resident in the agricultural material conveyor and is subsequently delivered when a stop command is provided to the agricultural material conveyor. For example, in some implementations, an agricultural material conveyor continues to run for a period of time in order to empty any agricultural material contained therein when a command to stop operation is received. This amount of agricultural material resident in the agricultural material conveyor and subsequently expelled during this period of time is anticipated by the selected weight. The amount of material resident in an agricultural conveyor along a length thereof may be known or stored in the controller 302, such as part of the software 318. The controller 302 can use this amount of agricultural material in the agricultural conveyor and subtract that amount of material from the selected weight to define a target weight. The controller 302 utilizes the target weight of agricultural material such that, when the target weight is received, feed of agricultural material to the agricultural material conveyor is stopped, but the agricultural material conveyor continues to operate to clear out the agricultural material remaining resident therein. Thus, the controller 302 is operable to provide the selected weight of agricultural material while also emptying the agricultural material conveyor. Operation in this way avoids loss of agricultural material within the agricultural material conveyor, such as when the agricultural material conveyor is retracted into a stowed position.

In some implementations, the instructions are transmitted by the transmitter 310 directly to the receiver 322 on the harvester. In other implementations, the transmitter 310 transmits the instructions to the receiver 322 via a communication network 324. For example, in some implementations, the network 324 is a cellular or mobile network, a wireless local area network (LAN), a wireless wide area network (WAN), or other types of wireless communication system that functions to receive, convey, and send communication signals.

In some implementations, a grain cart or harvester includes a fill detection system. Example fill detection systems within the scope of include those described in U.S. Pat. Nos. 8,868,304 and 9,119,342, both of which are incorporated by reference.

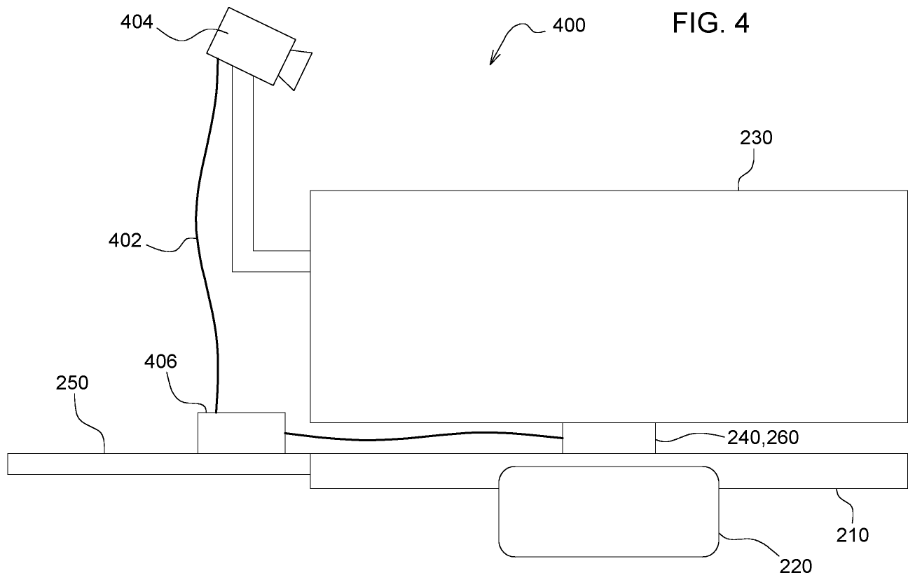

FIG. 4 illustrates another example grain cart 400, similar to grain cart 200, but also includes a fill detection system 402. Although the fill detection system 402 is shown local to the grain cart 400, in other implementations, the fill detection system 402 can be provided on a harvester that unloads agricultural material to the grain cart 400, or, in still other implementations, the fill detection system 402 may be distributed between a harvester and the grain cart 400. In still other implementations, one or more aspects of the fill detection system 402 is located at one or more locations other than a harvester and the grain cart 400.

The fill detection system 402 includes a fill sensor 404, such as on or more imaging sensors, communicably coupled to a controller 406. In some implementations, the controller 406 is a computer system similar to computer system 700, discussed in more detail below. Further, although a single fill sensor 404 is illustrated, other implementations may include additional fill sensors. Using the fill sensor 404, the controller 406 determines whether a fill level of agricultural material in a storage bin satisfies a selected condition, such as a fill level in the storage bin. When the sensed fill level satisfies the selected condition, the controller 406 stops operation of the agricultural material conveyor that is transferring the agricultural material to the grain cart 400.

Example imaging devices include one or more cameras (e.g., stereo cameras), lidar, radar, or other types of sensors utilizing electromagnetic radiation to detect agricultural material within the storage bin 230. In other implementations, the fill detection system 402 includes other sensors adapted to detect a level of agricultural material within the storage bin 230, such as one or more light sensors. In the illustrated example, the imaging device 404 detects a level of agricultural material in the storage bin 230 and sends signals representing the detected fill level to the controller 406. The controller 406 determines whether the detected fill level satisfies a selected condition. For example, the controller 406 determines whether the detected fill level satisfies a selected fill level such as by comparing the detected fill level to the selected fill level. In some instances, a selected fill level is a maximum fill level. Further, a selected fill level may be selected to prevent agricultural material from spilling out of the storage bin 230 of the grain cart 400 during transport over the ground. As explained earlier, topography of the ground may be used to define the selected fill level. If the detected fill level satisfied the selected condition, e.g., a maximum fill level, the controller 406 sends signals to cause filling of the storage bin 230 to stop. For example, the controller 406 sends signals to cause a transmitter to send instructions that cause the agricultural material conveyor, such as an agricultural material conveyor on a harvester, to cease operation.

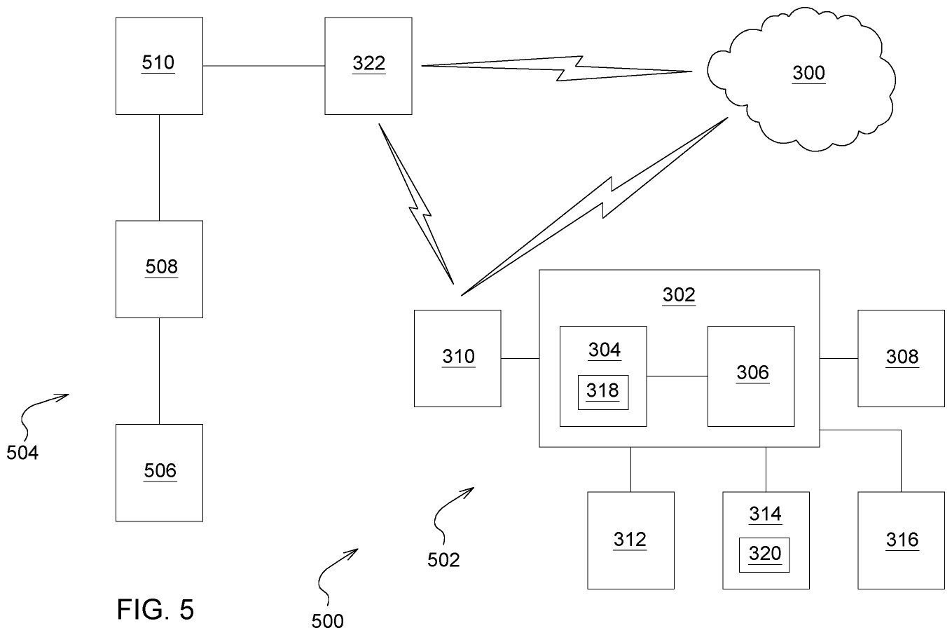

FIG. 5 is a schematic of another example control system 500. The control system 500 includes a weight detection system 502 that is similar to the control system 300 as well as a fill detection system 504 similar to the fill detection system 402. In the example of FIG. 5, the weight detection system 502 is located on a grain cart, and the fill detection system 402 is located remotely from the grain cart, such as onboard of a harvester that unloads agricultural material onto the grain cart. However, as explained earlier, these systems 502 and 504 can be distributed over different locations. In some implementations, the fill sensor 404 of the fill detection system 402 is an image sensor and is positioned on the harvester so as to image a storage bin of a grain cart as the grain cart is located adjacent to the harvester during an unloading operation.

The weight detection system 502 operates in a manner similar to that of the control system 300 described earlier. Using software 318, the controller 302 monitors a weight of agricultural material within a storage bin of the grain cart and, when the monitored weight satisfies a selected condition, the controller 302 causes the agricultural material conveyor of the harvester to cease operation. In some implementations, the fill detection system 504 utilizes one or more sensors 506, such as one or more image sensors (e.g., stereo cameras), to determine a fill level of the agricultural material in the storage bin of the grain cart. Other types of sensors may also be used. A controller 508, which may be similar to controller 406, described above, receives signals from the fill sensor 506 to detect a fill level of the agricultural material in the storage bin of the grain cart. When the detected fill level satisfies a selected condition, such as when the detected fill level reaches a selected fill level, the controller 508 sends signals to cause the agricultural material conveyor to cease operation. The controller 508 sends control signals directly or indirectly to the agricultural material conveyor to control operation thereof. Although two controllers 302 and 508 are described, in other implementations a single controller is used.

In some instances, because the controller 302 of the weight detection system 502 monitors a weight condition in light of first selected condition and the fill detection system 504 monitors a material fill level in light of a second selected condition, the control system 500 may encounter a circumstance in which one of the first or second conditions is satisfied with the other is not satisfied. In some implementations, controlling a weight of the agricultural material in a grain cart is a higher priority. Therefore, in some instances, the control system 500 ceases operation of an agricultural material conveyor when a selected weight condition exists in a storage bin of a grain cart notwithstanding that a selected fill condition has not been satisfied and, consequently, space exists in the storage bin for additional agricultural material.

In the illustrated example, the outputs of the controller 302 and controller 508 are transmitted to a controller 510. The controller 510 may be provided at any desired location and be in communication with controllers 302 and 508. Using the outputs from the controllers 302 and 508, the controller 510 determines how to control operation of the agricultural material conveyor. For example, the controller 302 may detect that a selected weight condition has been satisfied, while the controller 508 may determine that a selected fill condition has not been satisfied. The controller 510, using this information, transmits a signal to the agricultural material conveyor to cease operation notwithstanding that the selected fill condition has not been satisfied. Thus, in some instances, even where additional capacity exists within a storage bin, the agricultural material conveyor is stopped so as to limit a weight of the agricultural material present within the storage bin.

Although controller 510 is illustrated, in other implementations, controller 510 may be omitted and the functionality thereof incorporated into the controller 302 or 508. For example, if controllers 302 and 508 are provided at different locations, e.g., on different vehicles, then the output of one of the controller is transmitted to the other controller, and this other controller makes the determination based on both weight and fill information to continue operating an agricultural material conveyor or stop operation thereof upon one or both of the selected conditions being satisfied. In still other implementations, a single controller that provides the functionality described in the context of controllers 302, 508, and 510 is used.

In still other implementations, the controller 510 is omitted, and an output from either of the controllers 302 or 508 to stop operation of the conveyor operates to stop operation of the agricultural material conveyor notwithstanding that the other controller 508 has not generated a stop command to stop operation of the agricultural material conveyor.

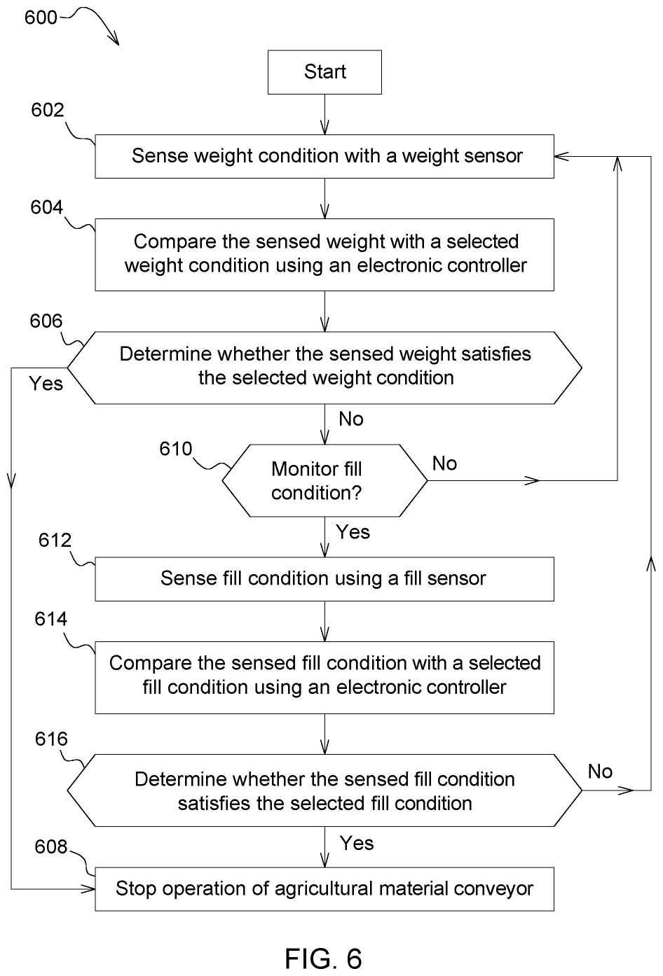

FIG. 6 is a flowchart of an example method 600 for controlling operation of an agricultural material conveyor using at least a detected weight of agricultural material in a storage bin of a grain cart or other vehicle. At 602, a weight of agricultural material in a storage bin of a vehicle, such as in a grain cart, is sensed. At 604, the sensed weight of the agricultural material is compared to a selected weight condition. The comparison is performed using a controller, such as controller 302. For example, the controller receives signals from a weight sensor and compares the received sensed weight to a selected weight condition. In some implementations, the selected weight condition is a maximum weight of agricultural material to be permitted in the storage bin. At 606, a determination is made as to whether the sensed weight of the agricultural material satisfies the selected weight condition. If the selected weight condition is satisfied, the method 600 moves to 608 where operation of an agricultural material conveyor that conveys the agricultural material to the storage bin is stopped. If a determination is made that the sensed weight of the agricultural material does not satisfy the selected weight condition, then the method 600 moves to 610 where a determination is as to whether a fill condition is to be monitored. A user may select whether a fill condition is desired to be monitored. In other instances, a fill monitoring system, which may be similar to fill detection system 504, may be absent or not otherwise employed. If a fill level of agricultural material in a storage bin of a vehicle is not desired or available, then the method 600 returns to 602 and the method 600 repeats until the selected weight condition is satisfied, at which point the method 600 moves to 608 and operation of the agricultural material conveyor is stopped.

If a fill level of agricultural material in a storage bin of a vehicle is desired, the method moves to 612, and a fill condition is sensed. For example, a fill condition is sensed using a fill detection system similar to fill detection system 504. At 614, the sensed fill condition is compared to a selected fill condition. At 616, a determination is made as to whether the sensed fill condition satisfies the selected fill condition. If the selected fill condition is not satisfied, the method returns to 602, and the method 600 continues therefrom until the selected weight condition or the selected fill condition is satisfied. If the selected fill condition is satisfied, the method moves to 608, and the agricultural material conveyor is stopped. For example, in some instances, the selected fill condition defines a maximum fill level, and the selected fill condition is satisfied when the sensed fill level reaches the maximum fill level.

The method 600 is performed electronically, for example, using a control system similar to control system 300 or 500, described earlier, so that monitoring of the weight condition, fill condition, or both are continuously monitored automatically and that stopping operation of an agricultural material conveyor is stopped upon detection of a selection condition occurs automatically. As a result, a workload of a user, such as an operator of a harvester or grain cart, is reduced. Further, automated monitoring of the selected condition or conditions is performed in a more efficient and timely manner, thereby reducing a risk of overfilling a grain cart or other vehicle into which agricultural material is being unloaded. In other implementations, an alert may be displayed to an operator, such as an operator of a harvester that is unloading the agricultural material, that a fill or weight condition has been satisfied, and the operator responds to the alert, such as by stopping operation of the agricultural material conveyor.

Without in any way limiting the scope, interpretation, or application of the claims appearing below, a technical effect of one or more of the example implementations disclosed herein is to control accurately and efficiently a weight of agricultural material unloaded from one agricultural vehicle to another. Control in this way can provide a user improved compliance with applicable road loading restrictions. Another technical effect of one or more of the example implementations disclosed herein is to reduce a workload of a user, such as an operator of a harvester or grain cart, thereby reducing a risk of overloading a vehicle due to fatigue or oversight. Operational safety is also improved.

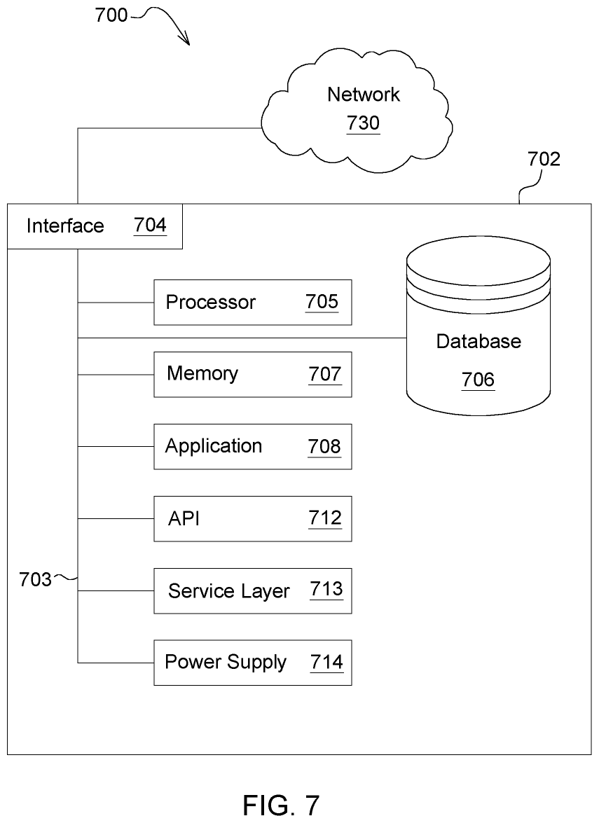

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Described implementations of the subject matter can include one or more features, alone or in combination.

For example, in a first implementation, a computer-implemented method for controlling transfer of agricultural material from a first vehicle to a second vehicle. The method may include sensing, with a first sensor, a weight of agricultural material contained in a storage bin of the second vehicle and being delivered to the storage bin via an agricultural material conveyor of the first vehicle; comparing, with an electronic controller, the sensed weight of the agricultural material with a selected condition; and transmitting a first signal to the agricultural material conveyor to stop operation of the agricultural material conveyor when the sensed weight of the agricultural material in the storage bin satisfies the selected condition.

The foregoing and other described implementations can each, optionally, include one or more of the following features:

A first feature, combinable with any of the following features, the method further including transferring the agricultural material from the first vehicle to the second vehicle while traveling over a surface.

A second feature, combinable with any of the previous or following features, the method further including detecting, with a second sensor, a fill level of the agricultural material in the storage bin; comparing the sensed fill level with a second selected condition; and transmitting a second signal to the agricultural material conveyor to stop operation of the agricultural material conveyor when the sensed fill level satisfies the second selected condition.

A third feature, combinable with any of the previous or following features, the method further including detecting, with a second sensor, a fill level of the agricultural material in the storage bin; comparing the sensed fill level with a second selected condition; and transmitting a second signal to the agricultural material conveyor to stop operation of the agricultural material conveyor when the sensed fill level satisfies the second selected condition.

A fourth feature, combinable with any of the previous or following features, wherein the second selected condition is a selected fill level.

A fifth feature, combinable with any of the previous or following features, wherein transmitting a first signal to the agricultural material conveyor to stop operation of the agricultural material conveyor when the sensed weight of the agricultural material in the storage bin satisfies the selected condition occurs notwithstanding that the sensed fill level does not satisfy the second selected condition.

A sixth feature, combinable with any of the previous or following features, wherein the second sensor is an image system.

A seventh feature, combinable with any of the previous or following features, wherein the imaging system comprises at least one camera.

An eighth feature, combinable with any of the previous or following features, wherein the at least one camera is at least one stereo camera.

A nineth feature, combinable with any of the previous or following features, wherein the first sensor is a scale.

A tenth feature, combinable with any of the previous features, wherein transmitting a first signal to the agricultural material conveyor to stop operation of the agricultural material conveyor when the sensed weight of the agricultural material in the storage bin satisfies the selected condition includes automatically stopping the agricultural material conveyor in response to receipt of the first signal.

In a second implementation, a computer-implemented system including one or more processors and a non-transitory computer-readable storage medium coupled to the one or more processors and storing programming instructions for execution by the one or more processors, the programming instructions instructing the one or more processors to sense, with a first sensor, a weight of agricultural material contained in a storage bin of a second vehicle and being delivered to the storage bin via an agricultural material conveyor of a first vehicle; compare, with an electronic controller, the sensed weight of the agricultural material with a selected condition; and transmit a first signal to the agricultural material conveyor to stop operation of the agricultural material conveyor when the sensed weight of the agricultural material in the storage bin satisfies the selected condition.

The foregoing and other described implementations can each, optionally, include one or more of the following features:

A first feature, combinable with any of the following features, further including one or more instructions executable by the one or more processors to transfer the agricultural material from the first vehicle to the second vehicle while traveling over a surface.

A second feature, combinable with any of the previous or following features, further including one or more instructions executable by the one or more processors to detect, with a second sensor, a fill level of the agricultural material in the storage bin; compare the sensed fill level with a second selected condition; and transmit a second signal to the agricultural material conveyor to stop operation of the agricultural material conveyor when the sensed fill level satisfies the second selected condition.

A third feature, combinable with any of the previous or following features, wherein the second selected condition is a selected fill level.

A fourth feature, combinable with any of the previous or following features, wherein the one or more instructions instructing the one or more processors to transmit a first signal to the agricultural material conveyor to stop operation of the agricultural material conveyor when the sensed weight of the agricultural material in the storage bin satisfies the selected condition includes programming instructions instructing the one or more processors to transmit the first signal to the agricultural material conveyor notwithstanding that the sensed fill level does not satisfy the second selected condition.

A fifth feature, combinable with any of the previous or following features, wherein the second sensor is an image system.

A sixth feature, combinable with any of the previous or following features, wherein the imaging system comprises at least one camera.

A seventh feature, combinable with any of the previous or following features, wherein the at least one camera is at least one stereo camera.

An eighth feature, combinable with any of the previous or following features, wherein the first sensor is a scale.

A nineth feature, combinable with any of the previous features, wherein the one or more instructions instructing the one or more processors to transmit a first signal to the agricultural material conveyor to stop operation of the agricultural material conveyor when the sensed weight of the agricultural material in the storage bin satisfies the selected condition includes programming instructions instructing the one or more processors to automatically stop the agricultural material conveyor in response to receipt of the first signal.

In a third implementation, a non-transitory, computer-readable medium storing one or more instructions executable by a computer system to perform operations including sensing, with a first sensor, a weight of agricultural material contained in a storage bin of a second vehicle and being delivered to the storage bin via an agricultural material conveyor of a first vehicle; comparing, with an electronic controller, the sensed weight of the agricultural material with a selected condition; and transmitting a first signal to the agricultural material conveyor to stop operation of the agricultural material conveyor when the sensed weight of the agricultural material in the storage bin satisfies the selected condition.

The foregoing and other described implementations can each, optionally, include one or more of the following features:

A first feature, combinable with any of the following features, the one or more instructions further including one or more instructions to perform the operations of transferring the agricultural material from the first vehicle to the second vehicle while traveling over a surface.

A second feature, combinable with any of the previous or following features, the one or more instructions further including one or more instructions to perform the operations of detecting, with a second sensor, a fill level of the agricultural material in the storage bin; comparing the sensed fill level with a second selected condition; and transmitting a second signal to the agricultural material conveyor to stop operation of the agricultural material conveyor when the sensed fill level satisfies the second selected condition.

A third feature, combinable with any of the previous or following features, wherein the second selected condition is a selected fill level.

A fourth feature, combinable with any of the previous or following features, wherein transmitting a first signal to the agricultural material conveyor to stop operation of the agricultural material conveyor when the sensed weight of the agricultural material in the storage bin satisfies the selected condition occurs notwithstanding that the sensed fill level does not satisfy the second selected condition.

A fifth feature, combinable with any of the previous or following features, wherein the second sensor is an image system.

A sixth feature, combinable with any of the previous or following features, wherein the imaging system comprises at least one camera.

A seventh feature, combinable with any of the previous or following features, wherein the at least one camera is at least one stereo camera.

An eighth feature, combinable with any of the previous or following features, wherein the first sensor is a scale.

A nineth feature, combinable with any of the previous features, the one or more instructions further including one or more instructions to perform the operations of transmitting a first signal to the agricultural material conveyor to stop operation of the agricultural material conveyor when the sensed weight of the agricultural material in the storage bin satisfies the selected condition includes one or more instruction to perform the operations of automatically stopping the agricultural material conveyor in response to receipt of the first signal.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A system to control transfer of agricultural material from one vehicle to another, the system comprising:
a first vehicle comprising:
a first storage bin that stores agricultural material; and
an agricultural material conveyor;
a second vehicle comprising:
a second storage bin that stores agricultural material conveyed by the agricultural material conveyor from the first storage bin of the first vehicle; and
a sensor that detects a weight of agricultural material contained in the second storage bin and generates a first signal representative of the detected weight;
a controller that is configured to:
receive the first signal and, using the received signals;
determine whether the detected weight satisfies a selected condition; and
stop operation of the agricultural material conveyor to stop transfer of agricultural material from the first vehicle to the second vehicle when the selected condition is satisfied.

2. The system of claim 1, wherein the controller comprises a controller configured to transmit a second signal to the first vehicle to stop operation of the agricultural material conveyor automatically.

3. The system of claim 1, wherein the selected condition is a selected weight of agricultural material contained in the second storage bin.

4. The system of claim 3, further comprising a fill level system configured to detect a fill level of agricultural material in the second storage bin of the second vehicle, wherein the controller is configured to determine when a fill level of the agricultural material in the second storage bin of the second vehicle has reached a selected fill level and cause the agricultural material conveyor to stop operation when the selected fill level has been reached.

5. The system of claim 4, wherein the controller is configured to stop operation of the agricultural material conveyor when the weight of the agricultural material in the second storage bin reaches selected weight notwithstanding that the fill level of the agricultural material in the second storage bin has not reached the selected fill level.

6. The system of claim 4, wherein the fill level system comprises an imaging system that detects a fill level of the second storage bin using image data.

7. The system of claim 6, wherein the imaging system comprises at least one camera.

8. The system of claim 7, wherein the at least one camera is at least one stereo camera.

9. The system of claim 1, wherein the agricultural material conveyor conveys the agricultural material from the first storage bin of the first vehicle to the second storage bin of the second vehicle as the first vehicle and second vehicle are traveling over a surface.

10. The system of claim 1, wherein the sensor comprises a scale coupled to the second storage bin.

11. A computer-implemented method for controlling transfer of agricultural material from a first vehicle to a second vehicle, the method comprising:
sensing, with a first sensor, a weight of agricultural material contained in a storage bin of the second vehicle and being delivered to the storage bin via an agricultural material conveyor of the first vehicle;
comparing, with an electronic controller, the sensed weight of the agricultural material with a selected condition; and
transmitting a first signal to the agricultural material conveyor to stop operation of the agricultural material conveyor when the sensed weight of the agricultural material in the storage bin satisfies the selected condition.

12. The computer-implemented method of claim 11, further comprising transferring the agricultural material from the first vehicle to the second vehicle while traveling over a surface.

13. The computer-implemented method of claim 11, further comprising:
detecting, with a second sensor, a fill level of the agricultural material in the storage bin;
comparing the sensed fill level with a second selected condition; and
transmitting a second signal to the agricultural material conveyor to stop operation of the agricultural material conveyor when the sensed fill level satisfies the second selected condition.

14. The computer-implemented method of claim 13, wherein the second selected condition is a selected fill level.

15. The computer-implemented method of claim 13, wherein transmitting a first signal to the agricultural material conveyor to stop operation of the agricultural material conveyor when the sensed weight of the agricultural material in the storage bin satisfies the selected condition occurs notwithstanding that the sensed fill level does not satisfy the second selected condition.

16. The computer-implemented method of claim 13, wherein the second sensor is an image system.

17. The computer-implemented method of claim 16, wherein the imaging system comprises at least one camera.

18. The computer-implemented method of claim 17, wherein the at least one camera is at least one stereo camera.

19. The computer-implemented method of claim 11, wherein the first sensor comprises a scale.

20. The computer-implemented method of claim 11, wherein transmitting a first signal to the agricultural material conveyor to stop operation of the agricultural material conveyor when the sensed weight of the agricultural material in the storage bin satisfies the selected condition comprises automatically stopping the agricultural material conveyor in response to receipt of the first signal.
